(19) United States
(12) Patent Application Publication
(10) Pub. No.: US 2010/0170789 A1
(43) Pub. Date: Jul. 8, 2010

(54) Microanalytical chip

(75) Inventors: Michinobu Mieda, Osaka (JP); Toshiaki Kitagawa, Osaka (JP); Toshiyuki Matsushima, Osaka (JP); Seung-jin Cho, Osaka (JP)

Correspondence Address: EDWARDS ANGELL PALMER & DODGE LLP, P.O. BOX 55874, BOSTON, MA, 02205, US

(73) Assignee: Sharp Kabushiki Kaisha, Osaka (JP)

(21) Appl. No.: 12/655,146

(22) Filed: Dec. 23, 2009

(30) Foreign Application Priority Data
Dec. 25, 2008 (JP) 2008-331416

(51) Int. Cl. G01N 27/26

(52) U.S. Cl. 204/403.01

(57) ABSTRACT

Provided is a microanalytical chip that is capable of controlling sequential sending of a plurality of solutions of mutually different viscosities and interfacial tensions. The microanalytical chip includes: a main conduit including a detecting portion and/or a reacting portion; a first introduction conduit and a second introduction conduit for introducing a solution to the main conduit from a further upstream position than the detecting portion and the reacting portion; and a third introduction conduit for introducing a. solution to the main conduit, wherein W2<W<Wm and W≦W1 are satisfied, wherein W1 denotes a minimum groove width of the first introduction conduit, W2 denotes a minimum groove width of the second introduction conduit, W3 denotes a minimum groove width of the third introduction conduit, and Wm denotes a minimum groove width of the main conduit.

### BACKGROUND OF THE INVENTION

1) Field of the Invention The present invention relates to microanalytical chips for use in micro-chemical analysis of biological or natural environmental materials, and more particularly to a microanalytical chip capable of smoothly transferring a plurality of sample solutions of mutually different viscosities and interfacial tensions.

2) Description of the Related Art

A widely used method for measuring proteins is immunity analysis such as ELISA (Enzyme-Linked ImmunoSorbent Assay), CLEIA (Chemiluminescent Enzyme Immunoassay), RIA (Radio Immunoassay), and LTIA (Latex Turbidimetric Immunoassay).

Immunity analysis is known as an important analysis/measurement method in, for example, the medical field, biochemical field, measurement field of allergen and the like. However, the conventional immunity analysis is complicated in operation and takes at least one day for analysis.

In view of these problems, a microanalytical chip is suggested having a micro-order conduit formed on a substrate to immobilize an antibody or the like on the conduit.

Analysis with a microanalytical chip involves a series of steps including: introducing a solution to a detecting portion or a reacting portion of the microanalytical chip through an introduction port or an introduction conduit; allowing the solution to have a reaction in the microanalytical chip; and discharging the solution to outside the microanalytical chip through a discharge port or a discharge conduit. Conventional microanalytical chips use external driving sources such as pumps and valves to transfer solutions. However, pumps and valves are large in size compared with microanalytical chips and make it difficult to downsize the devices as a whole. Although there is also a proposal to arrange a relatively small micropump or microvalve inside or outside the microanalytical chip, this method is not practical because complicated fine processing technology is involved.

As a simple method for transferring the solution within the chip, Japanese Patent Application Publication No. 2006-220606 proposes utilizing the capillarity of a hydrophilic conduit. FIG. 12 shows an example of a microanalytical chip that utilizes capillarity. With this microanalytical chip, a solution is dropped onto an inlet port 401 and then moved through a conduit 402 by capillarity, ending up being discharged to outside without external force from a pump or other means. As a method for discharging the solution that fills the conduit, Japanese Patent Application Publication No. 2000-297761 proposes providing a solution absorber on the discharge port so that the absorber absorbs the solution at the time of discharge thereof. Japanese Patent Application Publication No. 2003-149252 discloses use of a transparent or semi-transparent substrate material in optical detection using a microanalytical chip.

As a simple method for switching solution transfer (opening/closing solution flow), Japanese Patent Application Publication No. 2006-220606 proposes a microvalve (electrowetting valve) that utilizes electrowetting. FIG. 13 shows an example of a microanalytical chip that utilizes an electrowetting valve. Provided inside a conduit 402 of this microanalytical chip is an electrowetting valve that includes an operational electrode 405 and a reference electrode 406. The operational electrode 405 is hydrophobic on the surface without voltage applied thereto and hydrophilic with voltage applied thereto. Thus, the solution can be switched between transfer and stop (i.e., solution flow can be opened or closed) by application of voltage.

FIG. 14 shows an operational principle of an electrowetting valve. FIG. 14A shows a state without voltage application, and FIG. 14B shows a state of voltage application between the operational electrode 405 and the reference electrode 406. In the state without voltage application, the operational electrode 405 has a hydrophobic film 407 formed on the surface, and thus a solution 408 that is being moved through the conduit by capillarity is stopped upon reaching the operational electrode 405. Applying voltage makes the operational electrode 405 hydrophilic on the surface due to an electrowetting effect, which makes the stopped solution 408 pass over the operational electrode 405 and move through the conduit.

Incidentally, applications of the microanalytical chip include a judgment chip for metabolic syndrome.

Metabolic syndrome refers to disorders of carbohydrate and lipid metabolism caused by diminished effectiveness of insulin, which is a hormone to reduce blood sugar, due to lipid accumulation in internal organs. In many cases metabolic syndrome includes concurrent risk factors of arteriosclerotic diseases such as visceral fat obesity, high blood pressure, diabetes, and hyperlipidemia, and the concurrency increases the risk of arteriosclerotic diseases.

A diagnostic criteria of metabolic syndrome was presented in, for example, the National Cholesterol Education Program in 2001. According to this diagnostic criteria (NCEP-ATPIII), a person is diagnosed as a case of metabolic syndrome if at least three of the following five conditions are met:

(a) Waist circumference is equal to or more than a prescribed value (40 inches for male and 35 inches for female);

(b) Blood pressure is 130 mmHg or higher at the highest or 85 mmHg or higher at the lowest;

(c) Acylglycerol is equal to or more than 150 mg/dL;

(d) HDL-cholesterol is less than a prescribed value (40 mg/dL for male and 50 mg/dL for female); and

(e) Fₐₛting blood sugar of equal to or more than 110 mg/dL.

The above is no more than a diagnostic criteria used to determine metabolic syndrome cases after they occurred. Since metabolic syndrome can be prevented from occurring by practicing healthy living, it is vital to find a metabolic syndrome case in its early stages or prevent it and then carry out early treatment or practice healthy living. Thus, there is a strong need for a simple method for predicting occurrence or progress of metabolic syndrome.

In view of these circumstances, WO2005/038457 proposes, as a determination method of metabolic syndrome, a method for detecting a specific protein, such as adiponectin, that is related to occurrence of a metabolic syndrome case. Adiponectin is an insulin-sensitive hormone that is secreted specifically from fat cells and exists in the blood at relatively high concentrations (5 to 10 μg/mL). While being a protein secreted specifically from fat cells, adiponectin has significantly low blood concentrations in obese people. For example, reductions of the adiponectin concentration are observed in, for example, coronary artery disease and type 2 diabetes. Adiponectin can also be taken as a molecule related to both insulin resistance and arteriosclerosis.

Measuring the amount of adiponectin in the blood by immunity analysis requires preliminary treatment of a blood sample including removal (separation) of erythrocyte, disassembly (decomposition) of a multimer, and dilution. Examples of the separation method include centrifugal separation and filtering separation. Examples of the decomposition method include boiling treatment and a reaction with a reducing agent, a surface active agent, protease, or the like (e.g., see WO2005/038458).

### SUMMARY OF THE INVENTION

### Problems to be Solved by the Invention

If specific proteins, such as adiponectin, that are related to occurrence of metabolic syndrome can be detected by using microanalytical chips, diagnosis of metabolic syndrome cases and determination of the risk level of them will be simple and shortened in time.

However, the above-described conventional immunity analysis is complicated and time consuming. Specifically, measuring a protein contained in the blood such as adiponectin by immunity analysis such as ELISA using a microanalytical chip requires, in addition to sampling a blood sample and carrying out preliminary treatment thereof, sending a plurality of solutions of mutually different viscosities and interfacial tensions such as an enzyme-labeled antibody solution, a washing solution, and a substrate solution. This in turn requires solution sending control technology of these solutions.

Controlling solution sending is particularly difficult for microanalytical chips utilizing capillarity as driving force in the case of sending a plurality of solutions of mutually different viscosities and interfacial tensions, because each solution requires a different effective capillarity. Further, controlling sequential solution sending of a plurality of solutions of mutually different viscosities and interfacial tensions is difficult in the case of using microvalves utilizing electrowetting for corresponding solutions, because the valves are influential to each other.

The present invention has been achieved in view of the above problems, and it is an object of the present invention to provide a microanalytical chip capable of controlling and sequentially sending a plurality of solutions of mutually different viscosities and interfacial tensions, and thus to measure a specific protein in the blood in a simple and accurate manner.

### Means to Solve the Problems

In order to solve the above-mentioned problems, a microanalytical chip includes: a main conduit including a detecting portion and/or a reacting portion; a first introduction conduit and a second introduction conduit for introducing a solution to the main conduit from a further upstream position than the detecting portion and the reacting portion; and a third introduction conduit for introducing a solution to the main conduit, wherein W2<W1<Wm and W3≦W1 are satisfied, wherein W1 denotes a minimum groove width of the first introduction conduit, W2 denotes a minimum groove width of the second introduction conduit, W3 denotes a minimum groove width of the third introduction conduit, and Wm denotes a minimum groove width of the main conduit.

With this configuration, the microanalytical chip includes at least three introduction conduits for introducing a solution to the main conduit, with the minimum diameters of the conduits restricted to “W2<W1<Wm and W3≦W1.” This facilitates control of solution sending by allowing a solution of high viscosity or high interfacial tension (examples including a blood sample) to flow through the first introduction conduit, which has a largest minimum groove width, while allowing a solution of low viscosity or low interfacial tension (examples including a washing solution and a substrate solution) to flow through the second introduction conduit, which has a smaller minimum groove width than that of the first introduction conduit.

In this regard, the third introduction conduit may introduce a solution to the main conduit from a further upstream position than the detecting portion and the reacting portion, or from between the detecting portion and the reacting portion, or from a further downstream position than the detecting portion and the reacting portion.

In the above configuration, the microanalytical chip may further include: first to third valves respectively provided in the first to third introduction conduits, the first to third valves opening/closing solution flow.

This configuration facilitates sequential solution sending control of a plurality of solutions.

In the above configuration, the microanalytical chip may further include: a first substrate having formed thereon a groove for the main conduit, a groove for the first introduction conduit, a groove for the second introduction conduit, and a groove for the third introduction conduit; and a second substrate superposed on the first substrate and serving as a lid therefor.

This configuration simplifies the structure of the microanalytical chip.

The microanalytical chip of the present invention preferably carries out solution sending using capillarity as driving force.

In the above configuration, the first to third valves may be electrowetting valves. This facilitates the attempt to downsize the microchip.

Each electrowetting valve preferably has at least an operational electrode and a reference electrode, and further may have an opposing electrode. The operational electrode of each valve may be made of a metal thin film or of a metal thin film and a thin film provided on the metal thin film.

For a preferable operation, the thin film on the metal thin film preferably has a thickness of 100 nm or less. The thin film preferably has a contact angle of 80 degrees or more relative to pure water having a specific resistance of 18 MΩ·cm at 25° C. The thin film is preferably made of a substance containing a fluorine-containing substance or a thiol group.

The introduction conduit including the electrowetting valves is preferably such that its downstream end has a larger groove width than a groove width of the upstream end, in order to facilitate the flow of a stopped solution to the main conduit.

Preferably, the electrowetting valves each have an operational potential of 3V or less.

In the above configuration, the microanalytical chip preferably further includes: a discharge conduit connected to the main conduit at a down stream side; and a discharge portion connected to the discharge conduit.

Further, an absorber may be connected to the discharge conduit at a downstream end, in which case the absorber obtains stable capillarity. The absorber also absorbs liquid to prevent it from making the environment dirty.

The discharge conduit may have a valve for opening/closing solution flow. This enables a solution to be stopped at the main conduit located on an upstream side relative to the valve, thereby enhancing detection or reaction effectiveness.

The main conduit may be connected with an air flow path connected to an air hole. This further stabilizes solution sending with capillarity.

The minimum groove width of the air flow path is preferably larger than the first introduction conduit and less than the main conduit.

In order to further enhance the stability of solution sending, the air flow path is preferably located on an upstream side relative to the main conduit, and more preferably the air flow path is located on an upstream side relative to the main conduit while the discharge conduit is located on a downstream side relative to the main conduit.

The microanalytical chip of the present invention is suitable for detecting a protein, particularly adiponectin.

As has been described hereinbefore, the preset invention provides for a microanalytical chip capable of, without external force, stably controlling solution sending of a plurality of solutions of mutually different characteristics within the microanalytical chip, and thus of measuring a specific protein in a simple and highly accurate manner.

### BRIEF DESCRIPTION OF THE DRAWINGS

FIG. 1A is a plan view of a microanalytical chip according to embodiment 1, and FIG. 1B is a cross sectional view of the microanalytical chip according to embodiment 1.

FIG. 2A is a diagram showing structures of a first substrate of the microanalytical chip according to embodiment 1, and FIG. 2B is a second substrate of the microanalytical chip according to embodiment 1.

FIG. 3 is a plan view of a microanalytical chip according to example 1.

FIG. 4A is a diagram showing structure of a first substrate of the microanalytical chip according to example 1, and FIG. 4B is a second substrate of the microanalytical chip according to example 1.

FIG. 5 shows a result of measurement of an adiponectin concentration by the microanalytical chip according to example 1.

FIG. 6 is a diagram showing an introduction conduit at an operational electrode portion of a microanalytical chip according to example 3.

FIG. 7 is a plan view of a microanalytical chip according to embodiment 2.

FIG. 8A is a plan view of a preliminary treatment portion of the microanalytical chip according to embodiment 2, and FIG. 8B is a cross sectional view of the preliminary treatment portion of the microanalytical chip according to embodiment 2.

FIG. 9 is a plan view of a microanalytical chip according to example 4.

FIG. 10A is a plan view of a preliminary treatment portion of the microanalytical chip according to example 4, and FIG. 10B is a cross sectional view of the preliminary treatment portion of the microanalytical chip according to example 4.

FIGS. 11A and 11B are diagrams for illustrating the operation of the preliminary treatment portion of the microanalytical chip according to example 4, with FIG. 11A showing a plan view and 11B showing a cross sectional view.

FIG. 12 is a diagram showing a conventional example of a microanalytical chip utilizing capillarity.

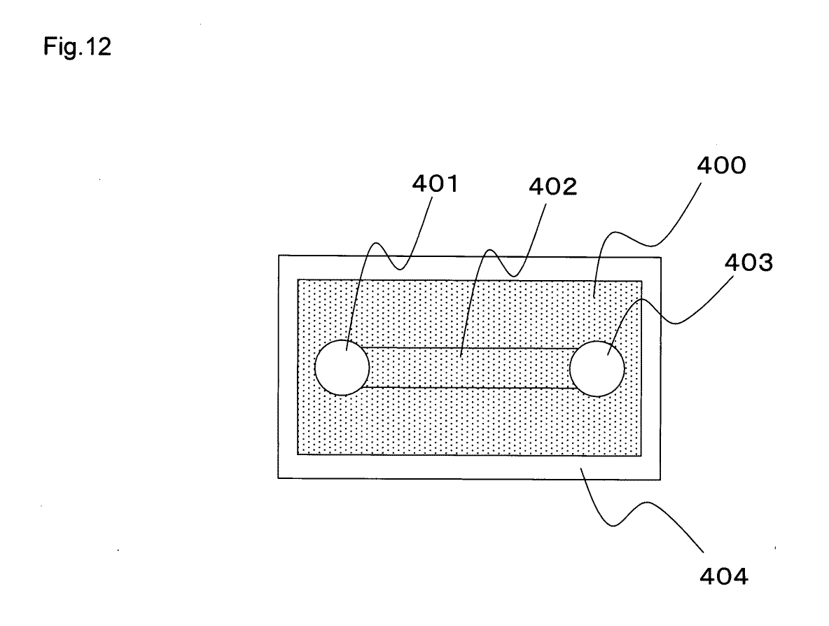

FIG. 13 is a diagram showing a conventional example of a microanalytical chip utilizing an electrowetting valve.

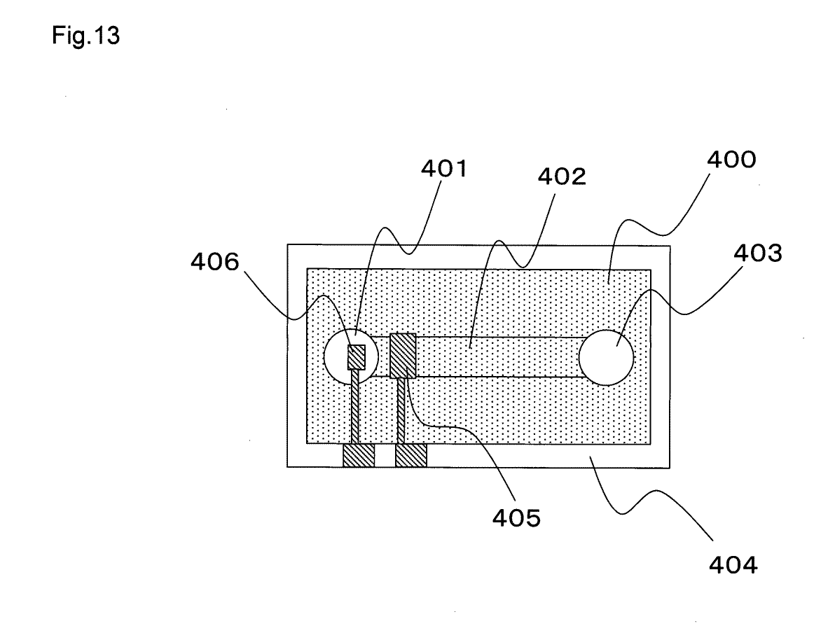

FIGS. 14A and 14B show the operational principle of an electrowetting valve, with FIG. 14A showing a state without voltage application and FIG. 14B showing a state of voltage application between an operational electrode and a reference electrode.

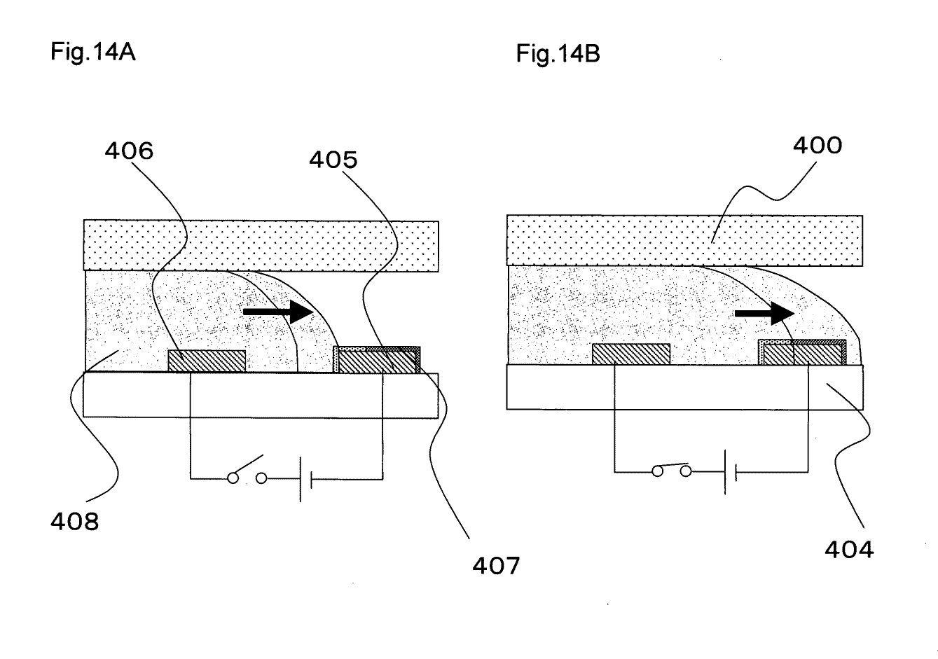

### DESCRIPTION OF THE PREFERRED EMBODIMENTS

The preferred embodiments of the present invention will be described in detail below. It should be noted that the following embodiments are not intended to be construed in a limiting sense, and modifications are possible without departing from the scope of the present invention.

The preferred embodiments of the present invention will be described by referring to the drawings.

### EMBODIMENT 1

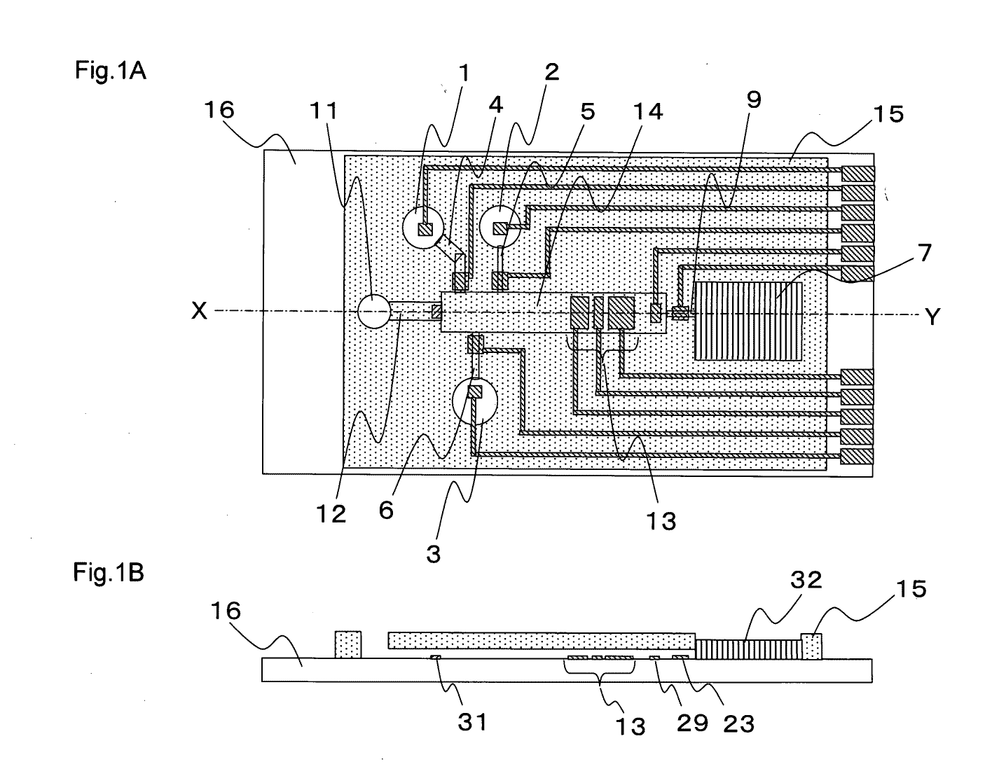

Referring to FIG. 1A, a microanalytical chip according to the present embodiment includes a main conduit 14 having a detecting portion 13, and open holes 1, 2, and 3 for introducing a solution into the chip. Also provided are first to third introduction conduits 4, 5, and 6 for introducing a solution to the main conduit 14 from a further upstream position than the detecting portion 13; a discharge conduit 9 provided on a downstream side of the main conduit; a discharge portion 7 provided on the discharge conduit 9 at its end; and an air flow path 12 connected to an air hole 11. The first to third introduction conduits 4, 5, and 6 are respectively provided with first to third valves for opening/closing solution flow.

FIG. 1B shows a X-Y cross section of FIG. 1A. The microanalytical chip according to the present embodiment is implemented by attaching a first substrate 15 having formed thereon grooves for the conduits and a second substrate 16 serving as a lid for the first substrate 15.

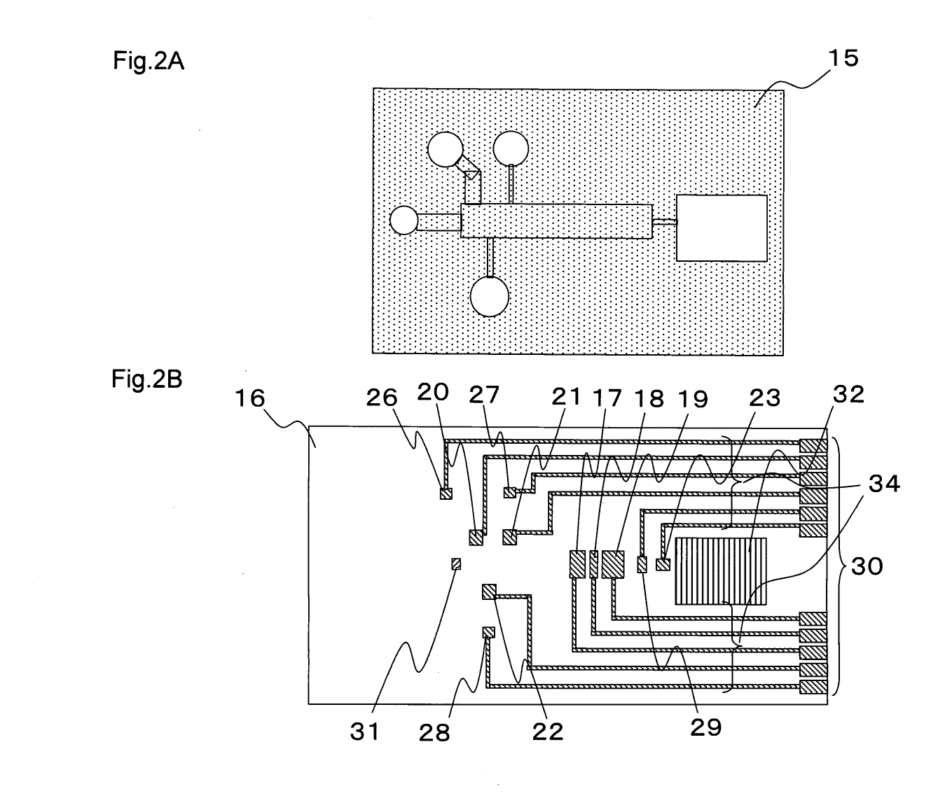

FIGS. 2A and 2B are diagrams showing structures of the first substrate 15 and the second substrate 16 of the microanalytical chip according to the present embodiment.

Referring to FIG. 2A, the first substrate 15 has formed thereon a groove for the main conduit 14, grooves for the first to third introduction conduits 4, 5, and 6, a groove for the discharge conduit 9, a hole for the discharge portion 7, a groove for the air flow path 12, a thorough hole for the air hole 11, and thorough holes for the open holes.

The groove widths of the first to third introduction conduits 4 to 6, the discharge conduit 9, the air flow path 12, and the main conduit 14 remain unchanged throughout respective flow directions. The main conduit 14 has a largest groove width, and the first introduction conduit 4 has a largest groove width among the first to third introduction conduits 4 to 6. The groove width of the air flow path 12 is larger than that of the first introduction conduit 4 and smaller than that of the main conduit 14.

Referring to FIG. 2B, the second substrate 16 is a substrate for sealing, from downward, the grooves and thorough holes formed on the first substrate 15. The second substrate 16 has formed thereon: detecting electrodes 17, 18, and 19 that constitute the detecting portion; electrowetting-valve operational electrodes 20, 21, 22, 23, and 24; electrowetting-valve reference electrodes 26, 27, 28, and 29; an electrode pad 30; a lead-out electrode 34; and a hydrophobic portion 31. The discharge portion 7 is provided with an absorber 32 that is in contact with the discharge conduit at its downstream end.

The first substrate 15 is approximately 0.1 to 10 mm thick and the second substrate 16 is approximately 0.01 to 10 mm thick. The open holes 1, 2, and 3 and the air hole 11 may be thorough holes of 10 μm or more in diameter.

In the case where the detecting portion of the microanalytical chip carries out optical detection, one or both of the first and second substrates 15 and 16 are preferably made of a transparent or semi-transparent material as those proposed in WO2005/038458. This is because such detection requires radiating exciting light to the test solution flowing within the main conduit 14 and detecting a fluorescence caused by the exciting light in order to measure the amount of the object substance, and thus no material that hinders fluorescence detection can be used. Examples of the transparent or semi-transparent material include glass, quartz, thermosetting resin, thermoplastic resin, and film. In particular, silicon resin, acrylic resin, and styrene resin are preferred for their transparency and moldability. It should be noted that there is no such material restriction in the case of electrochemical detection.

In the case where the detecting portion of the microanalytical chip carries out electrical control or electrical measurement, it is necessary to form electrodes in the substrate or on the surface thereof. In view of this, it is preferable to use an electrode-formable material for the substrate or one surface or both surfaces of the substrate. Preferable examples of the electrode-formable material include glass, quartz, and silicon for their productivity and reproducibility. It is preferable to form electrodes on a flat substrate (second substrate) since it is difficult for modern technology to form electrodes on rough portions.

Examples of the method for forming the conduits include direct processing of the substrate, mechanical working, laser processing, etching with chemicals or gas, injection molding with mold, press molding, and casting. The method using mold and the method involving etching are preferred for their high dimensional reproducibility.

While there is no particular limitation to the width and height of the main conduit 14, such dimensions are secured that permeation of a solution is realized by wetness thereof and the capillarity. The height is preferably set at approximately 1 μm to 5 mm, while the width is preferably set at approximately 1 μm to 5 mm.

The width and height of the grooves of the first to third introduction conduits 4, 5, and 6 are set at such dimensions that permeation of a solution is realized by wetness thereof and the capillarity in accordance with the characteristics of the solution flowing through the conduits such as viscosity and interfacial tension. The height is preferably set at approximately 1 μm to 5 mm, while the width is preferably set at approximately 1 μm to 1 mm.

The number of the introduction conduits is not limited to three and is set at a number that corresponds to the number of solutions needed for detection. In the case of measurement by immunity analysis, it is preferable to provide three or more introduction conduits. A part of the introduction conduits may be configured to introduce solutions to the main conduit from a further downstream position than the detecting portion.

The first to third introduction conduits 4, 5, and 6 each have formed therein an electrowetting valve serving to open/close solution flow, the valve at least having a reference electrode and an operational electrode.

The first to third introduction conduits 4, 5, and 6 respectively have formed therein electrowetting-valve operational electrodes 20, 21, and 22 and electrowetting-valve reference electrodes 26, 27, and 28 immediately under the open holes 1, 2, and 3 (i.e., on the upstream side of the operational electrodes).

The operational electrode and the reference electrode are wired to the electrode pad 30 through the lead-out electrode 34, and applied voltage is controlled by an external device (not shown) connected to the electrode pad 30, thereby carrying out the operation of each valve.

An introduction conduit on the operational electrode is preferably hydrophobic in a state without voltage application in order to reliably stop a solution. Specifically, it is preferable to make part of or the entire substrate 15 hydrophobic by, for example, using a hydrophobic material for the substrate 15 itself or forming a hydrophobic film on the substrate 15.

The operational electrodes 20, 21, and 22 are each formed of a gold thin film. It is also possible to use carbon or bismuth instead of gold. These materials are advantageous in that only a small amount of hydrogen or the like is generated in the state of voltage application to the operational electrode, thereby making the electrode less likely to deteriorate.

It is possible to form a thin film on each surface of the operational electrodes 20, 21, and 22, the thin film having a contact angle of 80 degrees or more relative to pure water having a specific resistance of 18 MΩ·cm at 25° C. This configuration reliably stops a solution in the state without voltage application, thereby realizing stable operation of the valve.

A suitable substance for this thin film contains a fluorine-containing substance or a thiol group. Use of one of these substances makes the contact angle of the thin film on the operational electrode larger than 90 degrees, which facilitates stopping of a solution at the valve in the state without voltage application, thereby realizing more stable operation of the valve. The thin film is not limited to the above substances and any other substance may be used insofar as it has on the surface a larger contact angle than the gold thin film.

The thin film on the gold thin film preferably has a thickness of 100 nm or less. This configuration reduces necessary voltage for operation of the valve, thereby downsizing the system.

The operational electrodes 20, 21, and 22 each may have formed thereon a metal thin film alone.

Exposing the metal surface to natural air results in a thin film (having a contact angle of 60 to 85 degrees) formed on the surface and made of a carbon deposit and other substance. Though having a contact angle of smaller than 90 degrees relative to pure water, this film has as low a hydrophilic degree as a contact angle of 60 to 85 degrees relative to pure water, and further is an extremely thin film of 1 nm or less. Thus, the thin film satisfactorily serves as an operational electrode of the electrowetting valve. This is also advantageous in that necessary voltage for operation of the valve is reduced compared with the case of forming the thin film in the above-described manner.

The groove width of an introduction conduit at the operational electrode portion is preferably as small as possible. This configuration facilitates stopping of a solution on the operational electrode in the state without voltage application, thereby realizing more stable operation of the valve. Preferably, the groove widths of the introduction conduits are set individually in accordance with the characteristics of solutions that flow through corresponding introduction conduits. This enables the capillarity of the valve portion to be adjusted in accordance with the characteristics of the solution, thereby providing the advantage of stably carrying out valve operation with respect to a plurality of different solutions. The width of the operational electrode portion is approximately 1 to 500 μm.

The groove width of each introduction conduit may not be constant, and the downstream side of the introduction conduit may be larger than the upstream side. This facilitates stopping of a solution at the valve and solution flow at a connection of the introduction conduit and the main conduit, thereby realizing more stable solution sending.

The electrowetting-valve reference electrodes 26, 27, and 28 are formed of silver/silver chloride. Use of silver/silver chloride is advantageous in that a potential change is small when current flows through the electrodes. It is also possible to use gold, carbon, or bismuth instead of silver/silver chloride.

While the voltage applied between the operational electrode and the reference electrode varies depending of the structure of the operational electrode, 3V or less is preferable. In the case where the operational electrode is composed of a gold thin film and a thin film formed by exposing the surface of the gold thin film to air, an operation with an applied voltage of 1V or less is possible. Reducing the applied voltage enables the system to be downsized, leading to mobile phone applications.

While in the present embodiment the electrowetting valve is of the two-electrodes system of the operational electrode and reference electrode, it is also possible to use a three-electrodes system with an opposing electrode added. Use of three electrodes makes the structure complicated with increased electrodes, but provides for the advantage of inhibiting variations in operational voltage.

While in the present embodiment an electrowetting valve is used as the microvalve, this is not intended to be construed in a limiting sense. It is also possible to use a valve capable of stopping or starting inflow of solution, such as a diaphragm valve.

While there is no limitation to the groove width and groove height of the discharge conduit 9, such dimensions are secured that permeation of a solution is realized by wetness thereof and the capillarity. The height is preferably set at approximately 1 μm to 5 mm, while the width is preferably set at approximately 1 μm to 5 mm.

While in the present embodiment a single discharge portion is provided, this is not intended to be construed in a limiting sense. Two or more discharge portions may be provided in accordance with the number or quantity of discharged solutions.

The discharge portion 7 is opened to atmosphere at the first substrate 15 side and provided at the second substrate 16 side with the absorber 32 connected to the downstream end of the discharge conduit.

The absorber refers to an absorber for liquid, examples including polymer absorbers, porous substances, hydrophilic meshes, corpus spongiosum, cotton, filter paper, and any other materials that absorb liquid utilizing capillarity.

This configuration enables liquid discharge to be carried out in a short period of time, thereby shortening the measurement time. Use of the absorber to absorb liquid provides for the advantage of preventing leakage of liquid to the outside.

The discharge conduit is provided with an electrowetting valve. The operational electrode 23 is formed on the discharge conduit 9, and the reference electrode 29 is formed on the main conduit 14 in the vicinity of the discharge conduit.

Providing a valve in the discharge conduit enables discharge control of liquid from the main conduit 14 to the discharge portion, thereby making it possible to stop liquid in the main conduit 14 for a predetermined period of time. Providing a valve in the discharge conduit also provides for the advantage of facilitating discharge of a predetermined amount of liquid.

The groove width and groove height of the air flow path 12 are set such that in the case of sequentially sending liquids to the main conduit 14 using a plurality of valves, the influence between the valves is minimized. The groove width of the air flow path 12 is preferably smaller than the groove width of the main conduit 14 and larger than the minimum groove widths of the first to third introduction conduits 4, 5, and 6.

Sequentially sending liquids by the present embodiment, which employs the air flow path 12, provides for the advantage of minimizing the influence between the valves, which prevents mal-operation of the valves, resulting in stable operation of the valves. The height is preferably set at approximately 1 μm to 5 mm, while the width is preferably set at approximately 1 μm to 1 mm. Provided in the vicinity of the boundary between the air flow path 12 and the main conduit 14 is the hydrophobic portion 31.

The hydrophobic portion 31 may be provided at a portion where the contact angle between the first substrate 15 and the second substrate 16 is 90 degrees or more. For example, the hydrophobic portion 31 may be formed by providing a hydrophobic material such as a fluorine hydrophobic agent and a negative resist at a part of the second substrate 16.

Providing the hydrophobic portion 31 prevents inflow of liquid into the air flow path 12, thus enabling the air flow path 12 to reliably serve as an air hole, thereby making it possible to stably operate a plurality of valves.

The air flow path 12 and the discharge conduit 9 are located on a side opposite to the detecting portion 13 provided in the main conduit 14. Specifically, the air flow path 12 is located on an upstream side relative to the main conduit 14, while the discharge conduit 9 is located on a downstream side relative to the main conduit 14.

This configuration provides for the advantage of reliably discharging the liquid in the main conduit 14, which minimizes quality degradation of a detection signal due to the influence of undischarged, remaining liquid, thereby realizing detection of preferable reproducibility.

The electrode pad 30 and the lead-out electrode 34 carry out, for example, input of an electric control signal and output of a detection signal. Use of a gold electrode simplifies the process because the step of preparation of the detection electrode can be used in common. It is also possible to use a conductive material containing platinum, aluminum, or copper. The microanalytical chip shown in FIG. 1 is capable of introduction solution sending control of a plurality of solutions and may be used to, for example, measure an antigen by immunity analysis, which includes: immobilizing an antibody or the like in the main conduit 14; effecting an antigen-antibody reaction by allowing a solution containing the antigen to flow through the main conduit 14; effecting an antigen-antibody reaction by allowing a solution containing an enzyme-labeled antibody to flow through the main conduit 14; effecting an enzyme substrate reaction by allowing a substrate solution to flow through the main conduit 14; and detecting at a detection electrode the amount of an electrode active substance resulting from the enzyme substrate reaction, thus measuring the amount of the antigen.

By following the procedure below, metabolic syndrome can be determined with the use of the inventive microanalytical chip with which to measure a specific protein, such as adiponectin, that is related to occurrence of a metabolic syndrome case.

(1) Immobilize an antibody on a detection electrode 17.

(2) From a first introduction conduit 4, introduce a mixture solution of a preliminarily treated (separated, diluted, and disassembled) blood sample and an enzyme-labeled antibody to a main conduit 14, stop the mixture solution for a predetermined period of time, and then discharge the mixture solution.

(3) From a second introduction conduit 5, introduce a washing buffer solution to the main conduit 14 and then discharge the washing buffer solution.

(4) From a third introduction conduit 6, introduce a substrate solution and stop it for a predetermined period of time.

(5) Measure the amount of protein contained in the blood sample by electrochemical detection.

This configuration simplifies and shortens in time the measurement of a specific protein by immunity analysis. Further, by measuring the amount of adiponectin, which is related to occurrence of metabolic syndrome cases, this configuration makes the measurement of metabolic syndrome simple and accurate. Furthermore, use of the inventive microanalytical chip provides for the advantage of downsizing the system and reducing the cost, leading to mobile phone applications.

Making the minimum diameters (minimum groove widths) of the first to third introduction conduits mutually different provides for the advantage of simplifying solution sending control by, for example, using the first introduction conduit, which has the largest diameter, for a high viscosity solution (blood sample) and the second or third introduction conduit, which have smaller diameters, for a low viscosity solution (washing solution or substrate solution).

While in the present embodiment description is made of the case of electrochemical detection, optical detection may be carried out. For example, such an optical measurement may be used that includes: immobilizing an antibody or the like in the main conduit 14; effecting an antigen-antibody reaction by allowing a solution containing an antigen to flow through the main conduit 14 from the first introduction conduit; washing the main conduit 14 by allowing a washing solution to flow through the second introduction conduit; effecting an antigen-antibody reaction by allowing a solution containing a labeled antibody attached with fluorescent dye from the third introduction conduit; and irradiating the main conduit 14 with exciting light and measuring the amount of the antigen from the amount of the resulting fluorescence.

### EMBODIMENT 2

Description will be made of a microanalytical chip of a structure different from embodiment 1 by referring to the drawings.

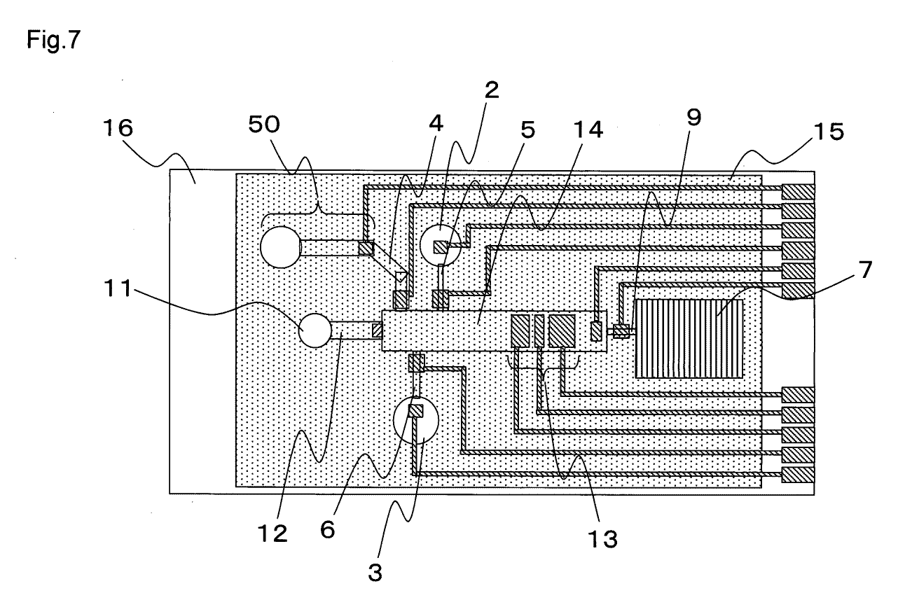

FIG. 7 shows a microanalytical chip according to the present embodiment.

The microanalytical chip according to the present embodiment is similar to embodiment 1 except that the introduction conduit 4 has a preliminary treatment portion 50 for carrying out preliminary treatment of liquid (such as separation of solid content and decomposition of a multimer). Thus, only the preliminary treatment portion 50 will be described in detail, with description of already-described portions omitted.

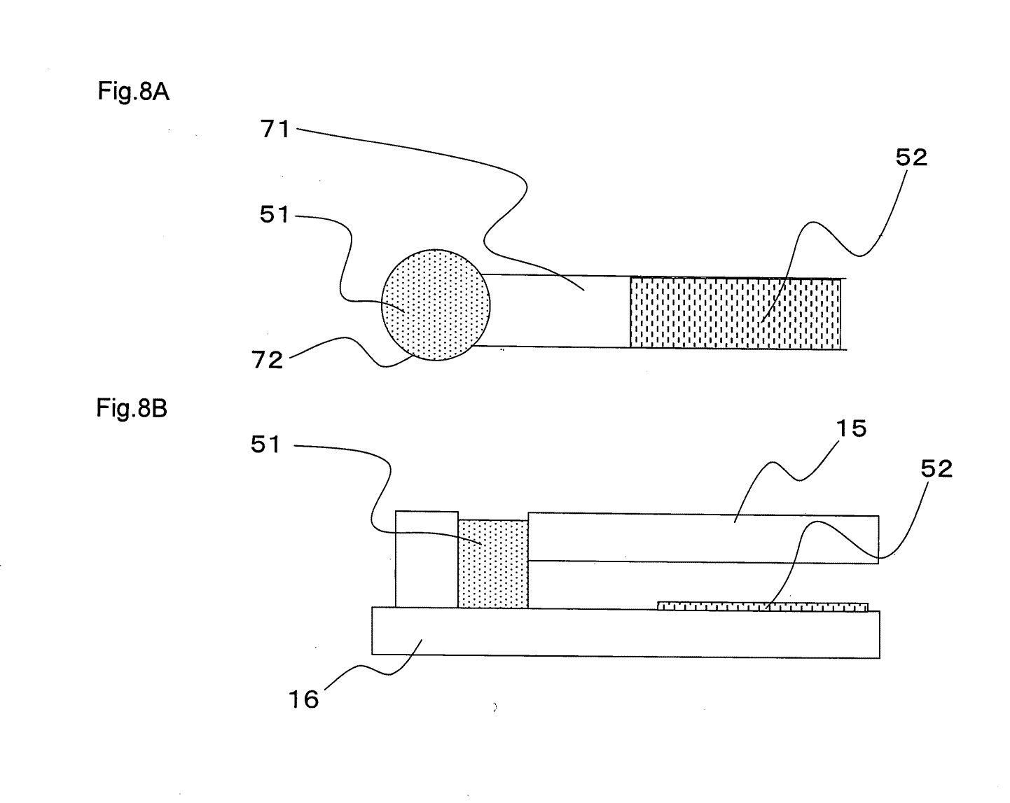

FIG. 8A is a plan view of the preliminary treatment portion 50 and FIG. 8B is a side view thereof. The first substrate 15 and the second substrate 16 are formed in the same manner as in embodiment 1.

The preliminary treatment portion 50 has a separation treatment portion 51 for removing erythrocyte contained in the blood sample serving as a measurement object, and a decomposition treatment portion 52 for disassembling a multimer. The decomposition treatment portion 52 is formed on a conduit 71, and the separation treatment portion 51 is formed in an injection hole 72.

While there is no particular limitation to the width and height of the conduit 71, such dimensions are secured that permeation of a solution is realized by wetness thereof and the capillarity. The height is preferably set at approximately 1 μm to 5 mm, while the width is preferably set at approximately 1 μm to 5 mm. The injection hole 72 may be a thorough hole of 10 μm or more in diameter.

The separation treatment portion 51 is provided with a filter for removing erythrocyte. Examples of the material of the filter include glass fiber, metal, nylon, polyester, and carbon. In particular, glass fiber is suitable for removing erythrocyte. A single filter may be used or two or more filters may be superposed on each other. Superposing two or more filters improves a separation property.

The separation method by the separation treatment portion 51 is not limited to use of a filter, and insofar as erythrocyte removal is secured, such a configuration is contemplated that a pillar structure dams up and removes erythrocyte.

The decomposition treatment portion 52 is provided with a heater for disassembling proteins contained in the blood by heat treatment. Examples of the material of the heater include nickel, chromium, tantalum, and nickel chromium alloy.

The decomposition method by the decomposition treatment portion 52 is not limited to heat treatment, and it is also possible to utilize a reaction with a reducing agent, a surface active agent, or the like.

While the present embodiment includes the separation treatment portion and the decomposition treatment portion, it is possible to employ either one of them alone. It is also possible for the preliminary treatment portion to include a dilution treatment portion or the like for carrying out dilution.

Use of the separation treatment portion 51 enables its filter to separate erythrocyte from blood injected through the injection hole 72 in order to disassemble adiponectin contained in the blood by heat treatment.

Thus, the microanalytical chip according to the present embodiment enables simple and accurate measurement of the adiponectin concentration in the blood without external preliminary treatment, thereby saving labor involved in the measurement.

### EXAMPLES

Next, the present invention will be described by referring to examples. It should be noted that the scope of the present invention will not be limited by the examples.

### Example 1

The present example relates to embodiment 1.

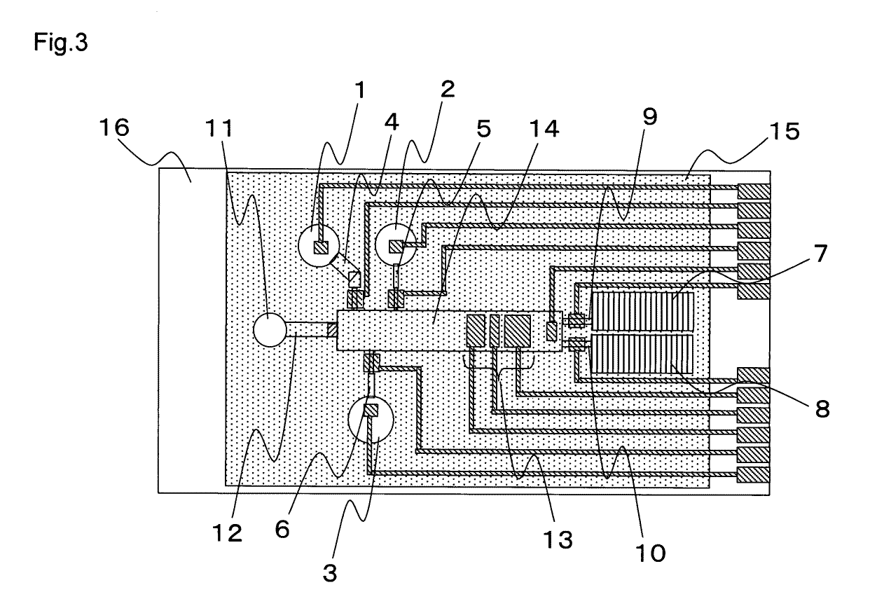

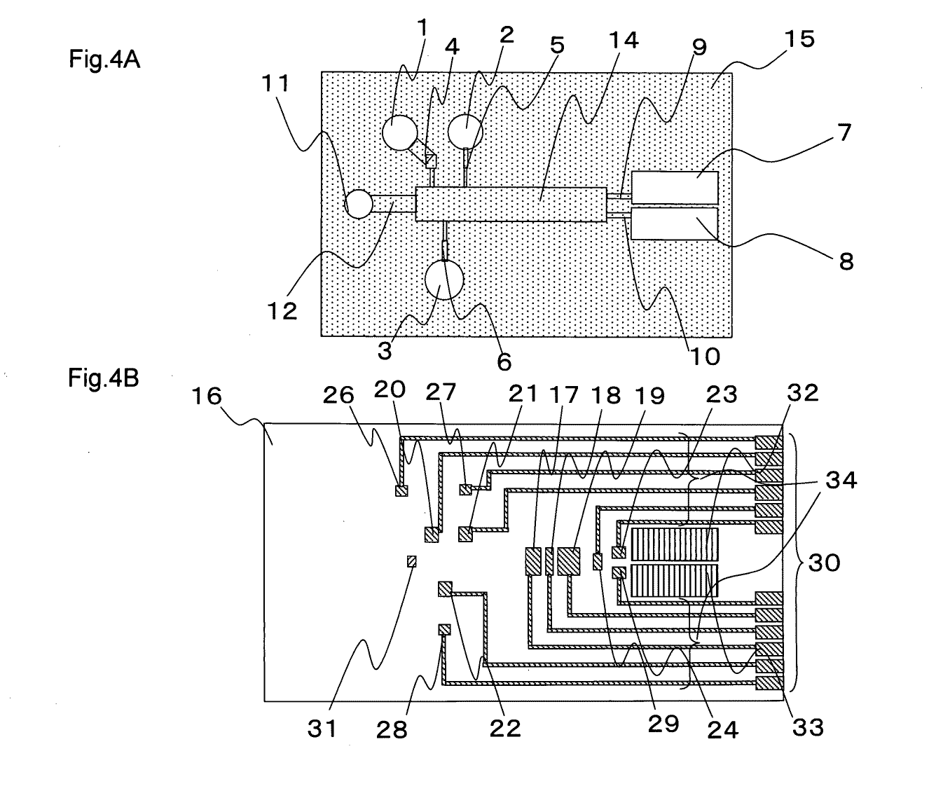

FIGS. 3, 4A, and 4B show a microanalytical chip according to the present example.

Referring to FIG. 3, the microanalytical chip according to the present example includes first to third introduction conduits 4, 5, and 6 respectively having open holes 1, 2, and 3 for introducing liquid to inside the chip, discharge conduits 9 and 10 respectively connected to two discharge portions 7 and 8, and an air flow path 12 connected to an air hole 11, all of which are connected to a main conduit 14 having a detecting portion 13.

Referring to FIGS. 4A and 4B, the microanalytical chip is composed of two substrates. A first substrate 15 has formed thereon a groove for the main conduit 14, thorough holes for the open holes 1, 2, and 3, grooves for the first to third introduction conduits 4, 5, and 6, grooves for the discharge conduits 9 and 10, holes for the discharge portions 7 and 8, a groove for the air flow path 12, and a thorough hole for the air hole 11. Referring to FIG. 4B, a second substrate 16 has formed thereon detecting electrodes 17, 18, and 19, electrowetting-valve operational electrodes 20, 21, 22, 23, 24, and 25, electrowetting-valve reference electrodes 26, 27, 28, and 29, an electrode pad 30, and a hydrophobic portion 31. The discharge portion is provided with absorbers 32 and 33. Resin molding using mold was used to preparation of the groove for the main conduit 14, the thorough holes for the open holes 1, 2, and 3, the grooves for the first to third introduction conduits 4, 5, and 6, the grooves for the discharge conduits 9 and 10, the holes for the discharge portions 7 and 8, the groove for the air flow path 12, and the thorough hole for the air hole 11, of the first substrate 15. The mold was prepared by resist-patterning a silicon substrate by photo-lithography and then etching such substrate by dry etching process. The prepared mold frame was fixed in place and fed 2 mm thick silicon rubber (polydimethyl siloxane: SILPOT184, available from Dow Corning Toray Co., Ltd.). Then the silicon rubber was cured by being heated at 100° C. for 15 minutes. After the curing, the cured silicon rubber was separated from the mold and adjusted in shape to a length of 15 mm, a width of 30 mm, and a thickness of 2 mm. Thus, the first substrate was prepared.

The first substrate 15 had the open holes 1, 2, and 3 formed as thorough holes of 2 mm in diameter and the air hole 11 formed as a thorough hole of 1 mm in diameter. The discharge portions 7 and 8 were formed using a mold into a shape that penetrates the first substrate 15.

The width of the main conduit 14 was set at 1000 μm, the width of the discharge conduits 9 and 10 was set at 50 μm, and the width of the air flow path 12 was set at 500 μm. The heights of all the conduits were set at 50 μm.

The widths of the introduction conduits were set in accordance with characteristics of flowing solutions such as viscosity. Specifically, the width of the first introduction conduit 4 was set at 400 μm, the width of the second introduction conduit 5 was set at 300 μm, and the width of the third introduction conduit 6 was set at 300 μm. (An exception was the valve operational electrode portion.)

The second substrate 16 was prepared by cutting a 600-μm thick quartz substrate to a length of 17 mm and a width of 34 mm with a dicing saw.

On the second substrate 16 were prepared in advance the detecting electrodes 17, 18, and 19, the electrowetting-valve operational electrodes 20, 21, 22, 23, 24, and 25, the electrowetting-valve reference electrodes 26, 27, 28, and 29, and the electrode pad 30.

The electrowetting-valve operational electrodes 20, 21, 22, 23, 24, and 25 were prepared by patterning a resist by photolithography, forming a titanium layer of 50 nm and a gold layer of 100 nm by sputtering, forming patterned electrodes by a lifting-off method. The dimensions of the electrowetting-valve operational electrodes were set at a length of 500 μm and a width of 500 μm.

The gold thin film is exposed to natural air in order to form on the surface a thin film (having a contact angle of 60 to 85 degrees) made of a carbon deposit and other substance.

The electrowetting-valve reference electrodes 26, 27, 28, and 29 were prepared by patterning a resist by photolithography, forming a silver layer of 1 μm by sputtering, and forming patterned electrodes by a lifting-off method. After preparation of the electrodes, the Ag surface was chloridized to prepare Ag/AgCl layered electrodes. The chloridization treatment was carried out by applying a voltage of +100 mV to the electrodes for 50 seconds in a 0.1 M hydrochloric acid. The dimensions of the electrowetting-valve reference electrodes set at a length of 1000 μm and a width of 1000 μm.

While in the present example the electrowetting valve is of the two-electrodes system of the operational electrode and reference electrode, it is also possible to use a three-electrodes system with an opposing electrode added. The microvalve may be other than the electrowetting valve. For example, it is possible to use a diaphragm valve, which is capable of stopping or starting inflow of solution.

The widths of the introduction conduits on the operational electrodes are smaller than the rest portions of the conduits and set in accordance with characteristics of flowing solutions such as viscosity. The width of the first introduction conduit 4 was set at 100 μm, the width of the second introduction conduit 5 was set at 50 μm, and the width of the third introduction conduit 6 was set at 30 μm.

The detecting electrode (operational electrode) 17, the detecting electrode (opposing electrode) 19, and the electrode pad 30 were prepared similarly to the above manner, i.e., by patterning a resist by photolithography, forming a titanium layer of 50 nm and a gold layer of 100 nm by sputtering, forming patterned electrodes by a lifting-off method. The dimensions of the detecting electrode 17 were set at a length of 1000 μm and a width of 1000 μm, and the dimensions of the detecting electrode 19 were set at a length of 1000 μm and a width of 1500 μm. With each electrode at a length of 1000 μm and a width of 1500 μm, the electrode pad 30 is formed at 0.05-inch intervals.

The detecting electrode (reference electrode) 18 was prepared by patterning a resist by photolithography, forming a silver layer of 1 μm by sputtering, and forming a patterned electrode by a lifting-off method. After preparation of the electrode, the Ag surface was chloridized to prepare a Ag/AgCl layered electrode. The chloridization treatment was carried out by applying a voltage of +100 mV to the electrode for 50 seconds in a 0.1 M hydrochloric acid.

In the present example, two discharge portions 7 and 8 of 2000 μm long and 6000 μm wide are provided. The discharge portions 7 and 8 are opened to atmosphere at the first substrate 15 side and respectively provided with absorbers 32 and 33 of cotton at the second substrate 16 side.

The discharge conduits 9 and 10 are provided with electrowetting valves. The discharge conduits 9 and 10 are respectively provided with the valve operational electrodes 23 and 24 and with the valve reference electrode 29 in the vicinity of the discharge conduit of the main conduit 14.

Provided in the vicinity of the boundary between the air flow path 12 and the main conduit 14 is a hydrophobic portion 31. The hydrophobic portion 31 is 500 μm long and 200 μm wide and formed by providing a fluorine hydrophobic agent (DURASURF, available from HARVES CO., Ltd.) on the second substrate 16.

The first substrate 15 and the second substrate 16 were subjected to oxygen plasma treatment under conditions 100W, 30 sccm oxygen flow rate, and 60 seconds, thereby enhancing the hydrophilicity of the surfaces. Then the first substrate 15 and the second substrate 16 were attached to one another by their self-adsorption effects, thus preparing the microanalytical chip according to example 1.

The microanalytical chip according to example 1 was subjected to a solution flow test.

From the open hole 1, a 2 μL mixture solution (a first solution) of a preliminarily treated blood sample and an enzyme-labeled antibody was injected; from the open hole 2, a 2 μL washing buffer solution (a second solution) was injected; and from the open hole 3, a 2 μL substrate solution (a third solution) was injected.

The injected solutions flowed through respective introduction conduits by the capillary phenomenon and stopped upon reaching the valve operational electrodes in respective introduction conduits. Although the first to third solutions had mutually different characteristics such as viscosity, the widths of the introduction conduits were set in accordance with corresponding flowing solutions, and therefore all the solutions smoothly moved through respective introduction conduits.

Next, by applying voltage between the operational electrode 20 and the reference electrode 26, the valve in the first introduction conduit 4 was turned on to introduce the first solution into the main conduit 14. The applied voltage was set at 1V. The first solution introduced into the main conduit 14 moved therethrough by the capillary phenomenon and stopped upon reaching the valve operational electrode in the discharge conduit.

Next, by applying 1V voltage between the operational electrode 23 and the reference electrode 29, the valve in the discharge conduit 7 was turned on to discharge the first solution into the discharge portion 7. The discharged first solution 1 was absorbed into the absorber 32 in the discharge portion 7, thus being completely discharged out of the main conduit.

When no air flow path 12 connected to the air hole 11 was provided, during discharge of the first solution, another solution from the second introduction conduit 5 or third introduction conduit 6 moved and erroneously entered the main conduit. However, providing the air flow path 12 prevented such mal-operation, thereby realizing stable solution discharge.

Next, by applying 1V voltage between the operational electrode 21 and the reference electrode 27, the valve in the second introduction conduit 5 was turned on to introduce the second solution into the main conduit 14. The second solution introduced into the main conduit 14 moved therethrough by the capillary phenomenon and stopped upon reaching the valve operational electrode in the discharge conduit.

Next, by applying 1V voltage between the operational electrode 24 and the reference electrode 30, the valve in the discharge conduit 8 was turned on to discharge the second solution into the discharge portion 8. The discharged second solution was absorbed into the absorber 33 in the discharge portion 8, thus being completely discharged out of the main conduit without mal-operation of the other valves.

Finally, by applying 1V voltage between the operational electrode 22 and the reference electrode 28, the valve in the third introduction conduit 6 was turned on to introduce the third solution into the main conduit 14. The third solution stopped upon reaching the valve operational electrode in the discharge conduit.

This proves that the present invention provides for stable sending and discharge of a plurality of solutions of mutually different characteristics without external driving sources.

Next, the microanalytical chip according to example 1 was used to measure a specific protein by immunity analysis.

As the specific protein, adiponectin, which is related to occurrence of metabolic syndrome cases, was measured for its concentration.

In the detecting electrode 17 in the main conduit 14, an antibody (R&D, MAB10651) was immobilized in advance. The method for immobilizing the antibody was physical adsorption by incubation at 37° C. for 10 minutes.

Instead of a blood sample, a sample solution was prepared having a varied concentration relative to that of adiponectin (R&D, 1065AP) and measured in the following procedure.

(1) From the first introduction conduit 4 was introduced to the main conduit 14 a 2 μL mixture solution of adiponectin (0, 10, 100, 500 ng/mL) and an enzyme (ALP)-labeled antibody (2.5 μg/mL). The mixture solution was stopped for 5 minutes and then discharged.

(2) From the second introduction conduit 5, a 2 μL washing tris buffer solution (10 mM of THAM (tris hydroxymethyl aminomethane), 137 mM of NaCl, 1 mM of MgCl, PH9.0) was introduced to the main conduit 14 and then discharged.

(3) From the third introduction conduit 6, a 2 μL substrate (1 mM of pAPP (p-Aminophenol phosphate)) solution was introduced to the main conduit 14 and then discharged.

(4) Five minutes thereafter, pAP (p-Aminophenol) resulting from reaction between the enzyme and the substrate was electrochemically detected (by cyclic voltammetry) at the electrodes of the detecting portion, and the adiponectin concentration dependency of a peak current value was measured.

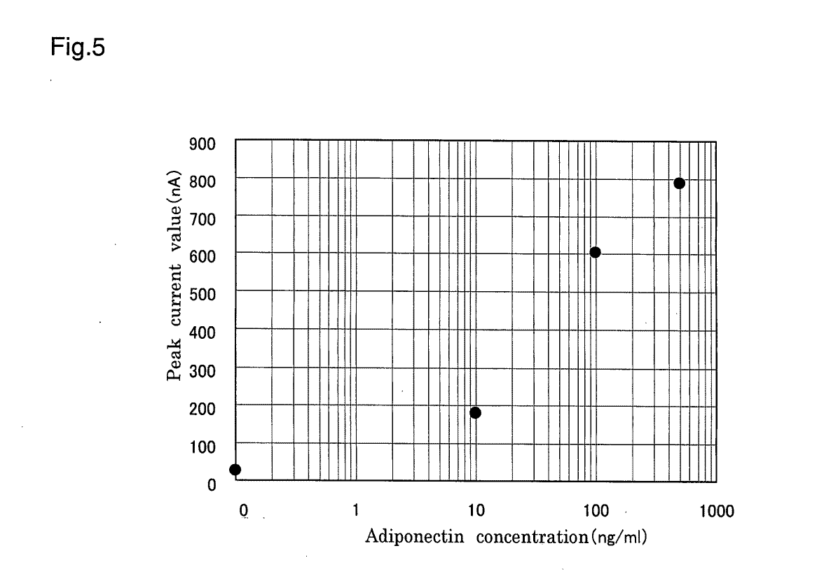

Results of the measurement are shown in FIG. 5. A calibration curve is obtained in the range of the adiponectin concentration between 10 to 500 ng/mL. This proves that the present invention provides for simple and shortened measurement of a specific protein by immunity analysis.

### Example 2

Next, description will be made of another example according to embodiment 1.

A microanalytical chip according to the present example is of the same structure as that of example 1 shown in FIGS. 3 and 4 except the valve operational electrode and the shape of the introduction conduit of the valve operational electrode portion.

Similarly to example 1, the width of the main conduit 14 was set at 1000 μm, the width of the discharge conduits 9 and 10 was set at 50 μm, and the width of the air flow path 12 was set at 500 μm. The heights of all the conduits were set at 50 μm.

The widths of the introduction conduits were set in accordance with characteristics of flowing solutions such as viscosity. Specifically, the width of the first introduction conduit 4 was set at 400 μm, the width of the second introduction conduit 5 was set at 300 μm, and the width of the third introduction conduit 6 was set at 300 μm.

On the second substrate 16 were prepared in advance the detecting electrodes 17, 18, and 19, the electrowetting-valve operational electrodes 20, 21, 22, 23, 24, and 25, the electrowetting-valve reference electrodes 26, 27, 28, and 29, and the electrode pad 30.

The electrowetting-valve operational electrodes 20, 21, 22, 23, 24, and 25 were prepared by patterning a resist by photolithography, forming a titanium layer of 50 nm and a gold layer of 100 nm by sputtering, forming patterned electrodes by a lifting-off method. The dimensions of the electrowetting-valve operational electrodes were set at a length of 500 μm and a width of 500 μm.

After preparation of the electrodes, blanked patterns were formed on the inner sides of the electrowetting-valve operational electrodes by photolithography. Then, C₄F₈ (octa-fluoro-cyclobutane) gas was introduced in plasma to deposit a 50-nm fluorocarbon film. In the deposition of the fluorocarbon film, an ICP apparatus (MUC-21) available from Sumitomo Precision Products, Co Ltd. was used. After deposition of the fluorocarbon film, the resist and the part of the fluorocarbon film formed on the resist were removed by a lifting-off method, thus forming the fluorocarbon film into a desired shape. The contact angle of the fluorocarbon film was 110 degrees (at room temperature (25° C.), with pure water (having a specific resistance of 18 MΩ·cm)). The widths of the introduction conduits on the operational electrodes are the same as the rest portions of the conduits and set in accordance with characteristics of flowing solutions such as viscosity. The width of the first introduction conduit 4 was set at 400 μm, the width of the second introduction conduit 5 was set at 300 μm, and the width of the third introduction conduit 6 was set at 300 μm.

The microanalytical chip according to example 2 was subjected to a solution flow test in a similar manner to example 1.

From the open hole 1, a 2 μL mixture solution (a first solution) of a preliminarily treated blood sample and an enzyme-labeled antibody was injected; from the open hole 2, a 2 μL washing buffer solution (a second solution) was injected; and from the open hole 3, a 2 μL substrate solution (a third solution) was injected.

The injected solutions flowed through respective introduction conduits by the capillary phenomenon and stopped before the valve operational electrodes in respective introduction conduits. Although the solutions had mutually different characteristics such as viscosity, the widths of the introduction conduits were set in accordance with corresponding flowing solutions, and therefore all the solutions smoothly moved through respective introduction conduits.

Next, by applying voltage between the operational electrode 20 and the reference electrode 26, the valve in the first introduction conduit 4 was turned on to introduce the first solution into the main conduit 14. The applied voltage was set at 1.5V. The first solution introduced into the main conduit 14 moved therethrough by the capillary phenomenon and stopped upon reaching the valve operational electrode in the discharge conduit.

Next, by applying 1.5V voltage between the operational electrode 23 and the reference electrode 29, the valve in the discharge conduit 7 was turned on to discharge the first solution into the discharge portion 7. The discharged first solution 1 was absorbed into the absorber 32 in the discharge portion 7, thus being completely discharged out of the main conduit.

Next, by applying 1.5V voltage between the operational electrode 21 and the reference electrode 27, the valve in the second introduction conduit 5 was turned on to introduce the second solution into the main conduit 14. The second solution introduced into the main conduit 14 moved therethrough by the capillary phenomenon and stopped upon reaching the valve operational electrode in the discharge conduit.

Next, by applying 1.5V voltage between the operational electrode 24 and the reference electrode 30, the valve in the discharge conduit 8 was turned on to discharge the second solution into the discharge portion 8.

The discharged second solution was absorbed into the absorber 33 in the discharge portion 8, thus being completely discharged out of the main conduit without mal-operation of the other valves.

Finally, by applying 1.5V voltage between the operational electrode 22 and the reference electrode 28, the valve in the introduction conduit 6 was turned on to introduce the third solution into the main conduit 14. The third solution stopped upon reaching the valve operational electrode in the discharge conduit.

Forming the fluorocarbon film on the operational electrodes made the contact angle on the operational electrodes larger than 90 degrees, which facilitated stopping of solutions at the valves, resulting in stable valve operation.

This proves that the present invention provides for stable sending and discharge of a plurality of solutions of mutually different characteristics without external driving sources.

Similarly to example 1, the microanalytical chip according to example 2 was used to measure a specific protein by immunity analysis. As a result, a calibration curve was obtained in the range of the adiponectin concentration between 10 to 500 ng/mL. This proves that the present invention provides for simple and shortened measurement of a specific protein by immunity analysis.

### Example 3

Next, description will be made of still another example according to embodiment 1.

A microanalytical chip according to the present example is of the same structure as that of example 1 shown in FIGS. 3 and 4 except the shape of the introduction conduit of the valve operational electrode portion.

Similarly to example 1, the width of the main conduit 14 was set at 1000 μm, the width of the discharge conduits 9 and 10 was set at 50 μm, and the width of the air flow path 12 was set at 500 μm. The heights of all the conduits were set at 50 μm.

The widths of the introduction conduits were set in accordance with characteristics of flowing solutions such as viscosity. Specifically, the width of the first introduction conduit 4 was set at 400 μm, the width of the second introduction conduit 5 was set at 300 μm, and the width of the third introduction conduit 6 was set at 300 μm. (An exception was the valve operational electrode portion.)

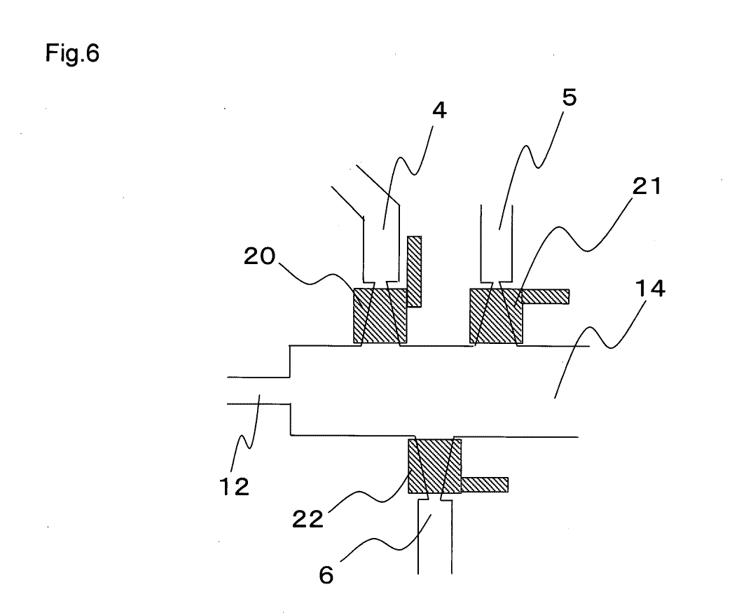

Referring to FIG. 6, the widths of the introduction conduits on the operational electrodes are such that downstream widths are larger than upstream widths, and set in accordance with characteristics of flowing solutions such as viscosity. Specifically, the width of the first introduction conduit 4 was set at 100 μm at the upstream portion and 300 μm at the downstream portion, the width of the second introduction conduit 5 was set at 50 μm at the upstream portion and 300 μm at the downstream portion, and the width of the third introduction conduit 6 was set at 30 μm at the upstream portion and 300 μm at the downstream portion.

The microanalytical chip according to example 3 was subjected to a solution flow test in a similar manner to example 1.

From the open hole 1, a 2 μL mixture solution (a first solution) of a preliminarily treated blood sample and an enzyme-labeled antibody was injected; from the open hole 2, a 2 μL washing buffer solution (a second solution) was injected; and from the open hole 3, a 2 μL substrate solution (a third solution) was injected.

The injected solutions flowed through respective introduction conduits by the capillary phenomenon and stopped upon reaching the valve operational electrodes in respective introduction conduits. Although the solutions had mutually different characteristics such as viscosity, the widths of the introduction conduits were set in accordance with corresponding flowing solutions, and therefore all the solutions smoothly moved through respective introduction conduits.

Next, by applying voltage between the operational electrode 20 and the reference electrode 26, the valve in the first introduction conduit 4 was turned on to introduce the first solution into the main conduit 14. The applied voltage was set at 1V. The first solution introduced into the main conduit 14 moved therethrough by the capillary phenomenon and stopped upon reaching the valve operational electrode in the discharge conduit.

Next, by applying 1V voltage between the operational electrode 23 and the reference electrode 29, the valve in the discharge conduit 7 was turned on to discharge the first solution into the discharge portion 7. The discharged first solution 1 was absorbed into the absorber 32 in the discharge portion 7, thus being completely discharged out of the main conduit.

Next, by applying 1V voltage between the operational electrode 21 and the reference electrode 27, the valve in the second introduction conduit 5 was turned on to introduce the second solution into the main conduit 14. The second solution introduced into the main conduit 14 moved therethrough by the capillary phenomenon and stopped upon reaching the valve operational electrode in the discharge conduit.

Next, by applying 1V voltage between the operational electrode 24 and the reference electrode 30, the valve in the discharge conduit 8 was turned on to discharge the second solution into the discharge portion 8. The discharged second solution was absorbed into the absorber 33 in the discharge portion 8, thus being completely discharged out of the main conduit without mal-operation of the other valves.

Finally, by applying 1V voltage between the operational electrode 22 and the reference electrode 28, the valve in the third introduction conduit 6 was turned on to introduce the third solution into the main conduit 14. The third solution stopped upon reaching the valve operational electrode in the discharge conduit.

Setting the width of each introduction conduit of the operational electrode portions such that the downstream width is larger than the upstream width facilitates stopping of solutions at the valves and flow of them at the connections of the introduction conduits and the main conduit, thus providing for stable solution sending.

This proves that the present invention provides for stable sending and discharge of a plurality of solutions of mutually different characteristics without external driving sources.

Similarly to example 1, the microanalytical chip according to example 3 was used to measure a specific protein by immunity analysis. As a result, a calibration curve was obtained in the range of the adiponectin concentration between 10 to 500 ng/mL. This proves that the present invention provides for simple and shortened measurement of a specific protein by immunity analysis.

### Example 4

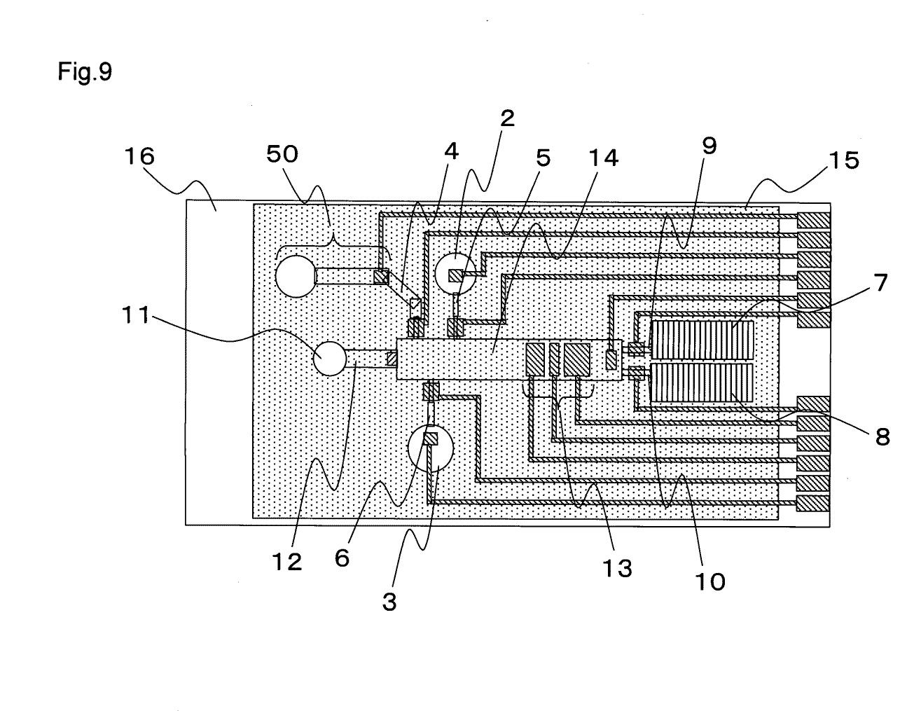

FIG. 9 shows a microanalytical chip according to the present example of embodiment 2.

The microanalytical chip according to the present example has, on an upstream side relative to the first introduction conduit 4, a preliminary treatment portion 50 for carrying out preliminary treatment of liquid. This microanalytical chip is of the same structure as example 1 other than the preliminary treatment portion 50.

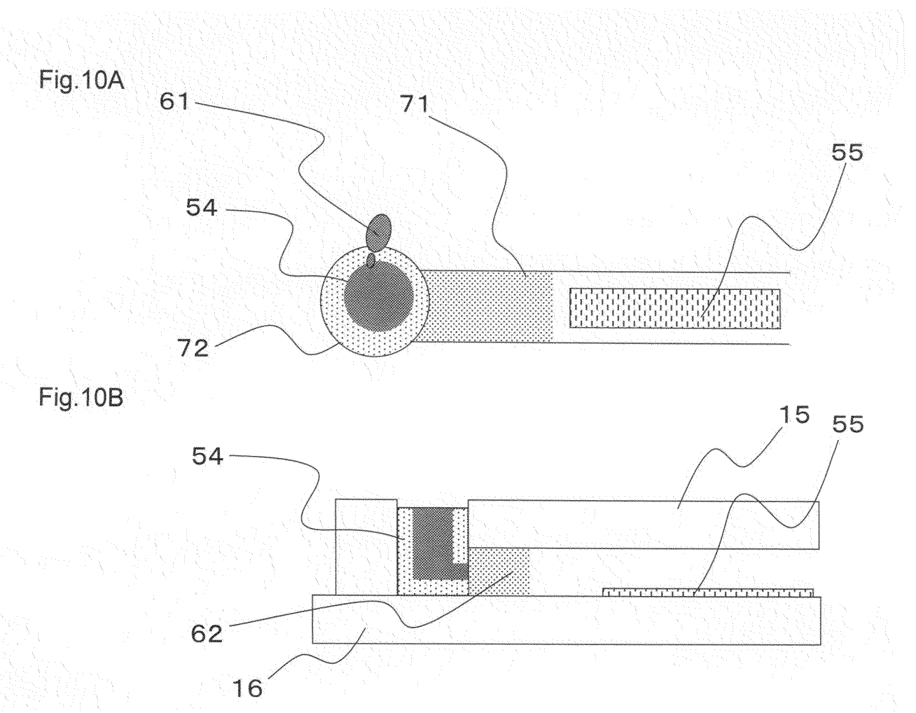

FIG. 10A shows a plan view of the preliminary treatment portion 50 for blood and FIG. 10B shows a side view thereof. The first substrate 15 and the second substrate 16 are formed by the same treatment method as in example 1.

The preliminary treatment portion 50 has a filter 54 for removing erythrocyte out of a blood sample, and a heater 55 for disassembling a multimer. The heater 55 is provided on a conduit 71, and the filter 54 is formed in an injection hole 72.

The conduit 71 was set at a width of 1000 μm and a height of 50 μm. The diameter of the injection hole 72 was set at 3 mm, and the filter 54 was provided inside the injection hole 72. The filter 54 was composed of two superposed glass fiber filter-papers 1GF/D of Whatman that were cut to 3 mm in outer diameter.

Inside the conduit 71, the heater 55 for disassembling proteins in the blood by heat treatment is located. As the heater 55, nickel-chromium alloy thin film heater was used to carry out heating by electrification.

The microanalytical chip according to the present example was used to carry out a preliminary treatment test of a simulated blood sample. The simulated blood included: a 80 mg/mL bovine albumin aqueous solution containing multimer human adiponectin; and as simulated erythrocyte, Microbead Micropshere of Polysciences, Inc. added to the aqueous solution at a concentration of 4.5×10⁶ pieces/μL.

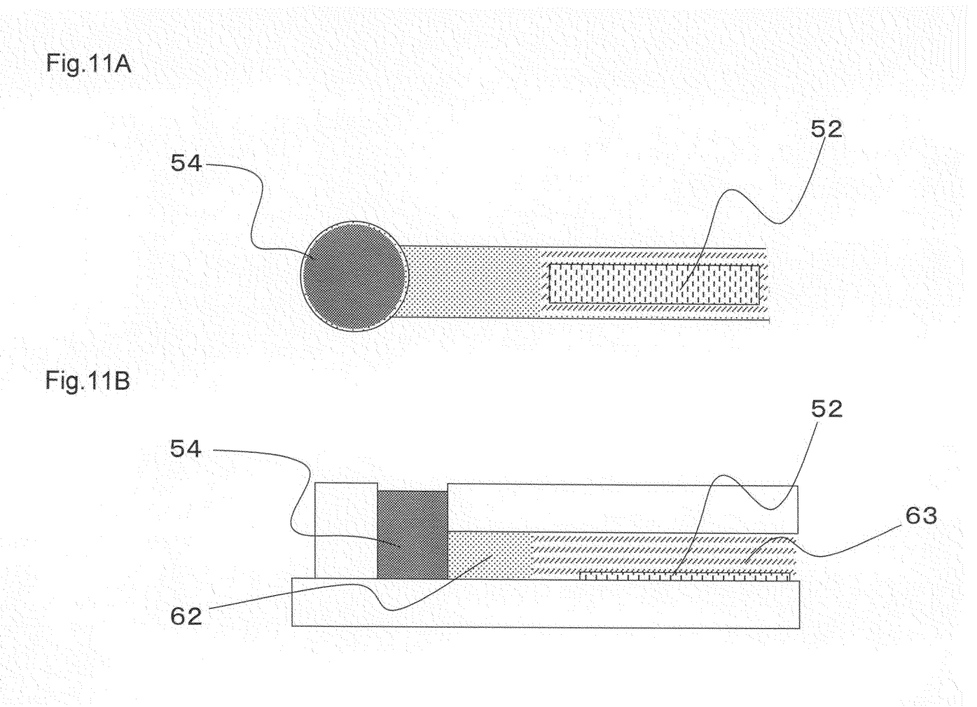

FIG. 11A shows a plan view of the preliminary treatment portion 50 at the time of injection of the simulate blood from the injection hole 72, and FIG. 11B shows a side view of such preliminary treatment portion 50.

From the simulated blood sample injected from the injection hole 72, simulated hematocytes were separated using the filter 54, and a sample 62 with the simulated hematocyte components removed was obtained. By subjecting the sample 62, which has the hematocyte components removed, to heat treatment results in a disassembled sample 63. The disassembly of adiponectin in the sample 62, which has the hematocyte components removed, was carried out by heat treatment under conditions of 100° C. and 5 minutes. The microanalytical chip according to the present example enabled separation and disassembly of hematocyte.

The microanalytical chip according to the present example enabled simple and accurate measurement of the adiponectin concentration in the blood without external preliminary treatment.

As has been described hereinbefore, the present invention provides for stable solution sending control of a plurality of solutions of mutually different characteristics without external driving sources, thereby realizing stable and simple measurement of a specific protein contained in the blood. Such microanalytical chip finds applications in, for example, metabolic syndrome determination analysis systems, and therefore the industrial applicability of the microanalytical chip is considerable.

What is claimed is:

1. A microanalytical chip comprising:
a main conduit including a detecting portion and/or a reacting portion;
a first introduction conduit and a second introduction conduit for introducing a solution to the main conduit from a further upstream position than the detecting portion and the reacting portion; and
a third introduction conduit for introducing a solution to the main conduit,
wherein W2<W1<Wm and W3≦W1 are satisfied, wherein W1 denotes a minimum groove width of the first introduction conduit, W2 denotes a minimum groove width of the second introduction conduit, W3 denotes a minimum groove width of the third introduction conduit, and Wm denotes a minimum groove width of the main conduit.

2. The microanalytical chip according to claim 1, further comprising first to third valves respectively provided in the first to third introduction conduits, the first to third valves opening/closing solution flow.

3. The microanalytical chip according to claim 2, further comprising:
a first substrate having formed thereon a groove for the main conduit, a groove for the first introduction conduit, a groove for the second introduction conduit, and a groove for the third introduction conduit; and
a second substrate superposed on the first substrate and serving as a lid therefor.

4. The microanalytical chip according to claim 3, wherein the microanalytical chip carries out solution sending using capillarity as driving force.

5. The microanalytical chip according to claim 3, wherein the first to third valves are electrowetting valves.

6. The microanalytical chip according to claim 5, wherein each of the first to third valves has an operational electrode made of a metal thin film.

7. The microanalytical chip according to claim 6, wherein a downstream end of the first conduit has a larger groove width than a groove width of an upstream end of the first conduit.

8. The microanalytical chip according to claim 5, wherein each of the first and second valves has an operational electrode made of a metal thin film and a thin film formed on the metal thin film.

9. The microanalytical chip according to claim 8, wherein the thin film has a thickness of 100 nm or less.

10. The microanalytical chip according to claim 8, the thin film has a contact angle of 80 degrees or more relative to pure water having a specific resistance of 18 MΩ·cm at 25° C.

11. The microanalytical chip according to claim 8, wherein the thin film is made of a substance containing a fluorine-containing substance or a thiol group.

12. The microanalytical chip according to claim 6, wherein the first to third valves each have an operational potential of 3V or less.

13. The microanalytical chip according to claim 3, further comprising:
a discharge conduit connected to the main conduit at a down stream side; and
a discharge portion connected to the discharge conduit.

14. The microanalytical chip according to claim 13, wherein the discharge portion has an absorber connected to the discharge conduit at a downstream end.

15. The microanalytical chip according to claim 13, wherein the discharge conduit has a valve for opening/closing solution flow.

16. The microanalytical chip according to claim 3, wherein the main conduit is connected with an air flow path connected to an air hole.

17. The microanalytical chip according to claim 16, wherein W1<W4≦Wm is satisfied, wherein W4 denotes a minimum groove width of the air flow path.

18. The microanalytical chip according to claim 16, wherein the air flow path is located on an upstream side relative to the main conduit.

19. The microanalytical chip according to claim 3, wherein the detecting portion detects a protein.

20. The microanalytical chip according to claim 19, wherein the protein is adiponectin.
